(19) United States
(12) Patent Application Publication
(10) Pub. No.: US 2022/0188980 A1
(43) Pub. Date: Jun. 16, 2022

(54) IMAGE PROCESSING APPARATUS, DISPLAY METHOD, AND DISPLAY PROGRAM

(71) Applicant: Konica Minolta, Inc., Tokyo (JP)

(72) Inventor: ATSUSHI TANEDA, Tokyo (JP)

(21) Appl. No.: 17/513,359

(22) Filed: Oct. 28, 2021

(30) Foreign Application Priority Data
Dec. 11, 2020 (JP) 2020-205645

(51) Int. Cl. G06T 5/00; G06T 7/00

(52) U.S. Cl. CPC G06T 5/001; G06T 2207/30004; G06T 2207/10116; G06T 7/0012

(57) ABSTRACT

An image processing apparatus includes: an image data generator that generates preview image data and main-image image data on the basis of an image signal acquired by a radiographic imaging apparatus; an image processor that performs enhancement processing for enhancing a signal component of a predetermined structure other than a human body on the preview image data generated by the image data generator; and a display controller that displays, on a display, a preview image based on the preview image data in which the signal component of the predetermined structure has been enhanced by the image processor.

The entire disclosure of Japanese patent Application No. 2020-205645, filed on Dec. 11, 2020, is incorporated herein by reference in its entirety.

### BACKGROUND

### Technological Field

The present invention relates to an image processing apparatus, a display method, and a display program.

### Description of the Related Art

Conventionally, there is known a radiographic imaging system that captures a radiographic image of a subject with a radiographic imaging apparatus, transfers the read image data to an image display device (display), performs predetermined image processing on the image data, and displays the radiographic image of the subject. In such a system, a configuration is known in which, before a main image that is a result of image capture of the radiographic image is displayed, a preview image subjected to image processing simpler than that performed on the main image is displayed on a display, for example (see, for example, JP 2012-120724 A and JP 2018-157869 A).

In addition, in order to check whether or not a structure other than a human body, such as a catheter or a gauze, is present within the body of a subject, there is known a configuration in which enhancement processing is performed on a structure in image data related to an image captured by a radiographic imaging system so that the presence of the structure can be easily checked (see, for example, JP 2018-68863 A).

Meanwhile, in a radiographic imaging system, it is common that a non-enhanced image that is not subjected to enhancement processing is displayed first, and when an operation of switching the display to an image subjected to the enhancement processing is performed, the image is displayed on a display.

That is, in the conventional radiographic imaging system, a user needs to perform the operation described above after the non-enhanced image is displayed, which is inconvenient for the user. In addition, in a case where it is desired to quickly check whether or not a structure (such as a gauze) other than the human body is present within the body of the subject, such as during surgery or the like, it may take time to check an image related to the inside of the subject.

### SUMMARY

An object of the present invention is to provide an image processing apparatus, a display method, and a display program with which it is possible to quickly check whether or not a structure is present within the body of a subject and to consequently improve the immediacy of checking an image in a radiographic imaging system.

To achieve the abovementioned object, according to an aspect of the present invention, an image processing apparatus reflecting one aspect of the present invention comprises: an image data generator that generates preview image data and main-image image data on the basis of an image signal acquired by a radiographic imaging apparatus; an image processor that performs enhancement processing for enhancing a signal component of a predetermined structure other than a human body on the preview image data generated by the image data generator; and a display controller that displays, on a display, a preview image based on the preview image data in which the signal component of the predetermined structure has been enhanced by the image processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration of a radiographic imaging system according to an embodiment of the present invention;

FIG. 2 is a block diagram illustrating a configuration of a radiographic imaging apparatus;

FIG. 3 is a block diagram illustrating a configuration of a console;

FIG. 4 is a block diagram illustrating an imaging controller;

FIG. 5A is a view illustrating an example of an image subjected to enhancement processing;

FIG. 5B is a view illustrating an example of an image not subjected to enhancement processing;

FIG. 6 is a flowchart illustrating an operation example of enhancement processing control for a preview image by the imaging controller; and

FIG. 7 is a flowchart illustrating an operation example of enhancement processing control for an image by the imaging controller.

### DETAILED DESCRIPTION OF EMBODIMENTS

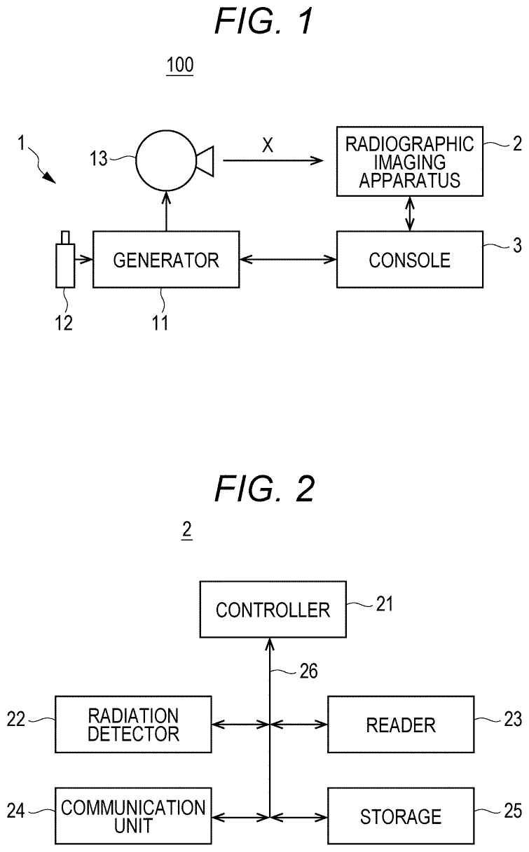

Hereinafter, one or more embodiments of the present invention will be described with reference to the drawings. However, the scope of the invention is not limited to the disclosed embodiments. FIG. 1 is a block diagram illustrating a configuration of a radiographic imaging system 100 according to an embodiment of the present invention.

As illustrated in FIG. 1, the radiographic imaging system 100 according to the present embodiment includes a radiation irradiation apparatus 1, a radiographic imaging apparatus 2, and a console 3. In addition, the radiographic imaging system 100 is connectable to a radiology information system (RIS), a picture archiving and communication system (PACS), and the like which are not illustrated.

The radiation irradiation apparatus 1 is communicably connected to the console 3 wirelessly or by wire. The radiation irradiation apparatus 1 includes a generator 11, an exposure switch 12, and a radiation source 13.

The generator 11 is configured to be able to apply a voltage corresponding to a preset radiation exposure condition (tube voltage, tube current, irradiation time, tube current time product (mAs value), and the like) to the radiation source 13 in response to the exposure switch 12 being operated.

The radiation source 13 (bulb) includes a rotating anode, a filament, and the like (not illustrated). When a voltage is applied from the generator 11, the filament irradiates the rotating anode with an electron beam corresponding to the applied voltage so that the rotating anode generates a radiation X (such as an X-ray) of a dose corresponding to the intensity of the electron beam.

Note that, although FIG. 1 illustrates the generator 11, the exposure switch 12, and the radiation source 13 which are separately provided, they may be integrated. In addition, FIG. 1 illustrates an example in which the exposure switch 12 is connected to the generator 11, but the exposure switch 12 may be provided in another device. Further, the radiation irradiation apparatus 1 may be installed in an imaging room or may be configured to be movable by being mounted on a ward round trolley, etc.

The radiographic imaging apparatus 2 is communicably connected to the console 3 wirelessly or by wire. The radiographic imaging apparatus 2 is configured to be capable of generating image data of a radiographic image of a subject by receiving radiation X from the radiation irradiation apparatus 1 via the subject.

As illustrated in FIG. 2, the radiographic imaging apparatus 2 includes a controller 21, a radiation detector 22, a reader 23, a communication unit 24, a storage 25, and a bus 26 that connects these elements.

The controller 21 includes a central processing unit (CPU), a random access memory (RAM), and the like. When receiving a control signal, etc. from an external device such as the console 3, the CPU of the controller 21 reads various programs stored in the storage 25, expands the read programs in the RAM, executes various processes in accordance with the expanded programs, and centrally controls operation of each element in the radiographic imaging apparatus 2.

The radiation detector 22 includes a substrate in which pixels each including a radiation detection element that generates electric charges corresponding to a dose in response to the radiation X and a switch element are arranged two-dimensionally (in a matrix).

The reader 23 is configured to be able to read an amount of electric charges emitted from each pixel as a signal value and generate image data from a plurality of signal values.

The communication unit 24 is configured to be able to receive (acquire) various control signals, various kinds of data, and the like from an external device, and transmit various control signals, generated image signals, and the like to the external device.

The storage 25 includes a nonvolatile semiconductor memory, a hard disk, or the like, and stores various programs executed by the controller 21, parameters necessary for execution of processing by the programs, and the like. Furthermore, the storage 25 can store image data generated by the reader 23 and various kinds of data processed by the controller 21.

When the controller 21 receives radiation exposure in a state in which each switch element of the radiation detector 22 is turned off, the radiographic imaging apparatus 2 configured as described above accumulates electric charges corresponding to the dose of radiation in each pixel. When the controller 21 turns on each switch element to discharge electric charges from each pixel, the reader 23 converts an amount of each electric charge into a signal value and reads the signal value as image data.

Note that the radiographic imaging apparatus 2 may incorporate a scintillator or the like, convert the emitted radiation X into light of another wavelength such as visible light by the scintillator, and generate electric charges corresponding to the converted light, or may generate electric charges directly from the radiation X without using a scintillator or the like. The radiographic imaging apparatus 2 may be a dedicated apparatus integrated with a radiographic stand, or may be a portable apparatus such as a flat panel detector (FPD).

The console 3 includes a personal computer (PC), a portable terminal, or a dedicated device, and is communicably connected to the radiation irradiation apparatus 1, the radiographic imaging apparatus 2, etc. wirelessly or by wire. The console 3 can set imaging conditions of the radiation irradiation apparatus 1 and the radiographic imaging apparatus 2, parts to be imaged, and the like on the basis of an imaging order from an external device (RIS or the like) or an operation performed by a user.

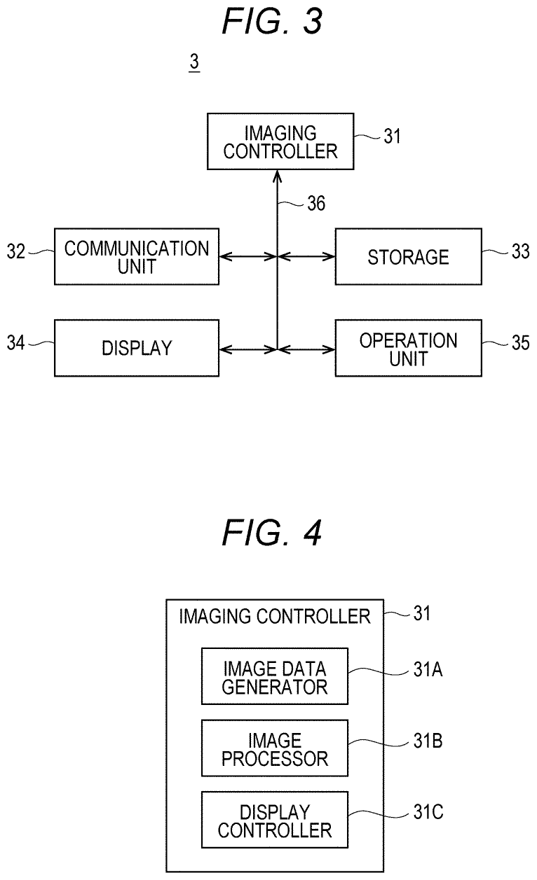

As illustrated in FIG. 3, the console 3 includes an imaging controller 31, a communication unit 32, a storage 33, a display 34, an operation unit 35, and a bus 36 that connects these elements.

The imaging controller 31 includes a CPU, a RAM, and the like. The CPU of the imaging controller 31 reads various programs stored in the storage 33 according to the operation performed on the operation unit 35, expands the programs in the RAM, executes various processes according to the expanded programs, and centrally controls the operation of each element of the console 3.

In addition, the imaging controller 31 performs image processing for generating an image to be displayed on the display 34 on the basis of the image signal acquired by the radiographic imaging apparatus 2. Details of control related to image processing in the imaging controller 31 will be described later.

The communication unit 32 includes a local area network (LAN) adapter, a modem, a terminal adapter (TA), and the like, and controls data transmission and reception with each device connected to a communication network.

The storage 33 includes a nonvolatile semiconductor memory, a hard disk, or the like, and stores various programs executed by the imaging controller 31, parameters necessary for execution of processing by the programs, and the like. The storage 33 can store the image data received from the radiographic imaging apparatus 2 and the image data processed by the imaging controller 31 in association with supplementary information.

The display 34 includes a monitor such as a liquid crystal display (LCD) or a cathode ray tube (CRT), and displays an input instruction, data, or the like from the operation unit 35 in accordance with an instruction of a display signal input from the imaging controller 31.

The operation unit 35 includes a keyboard provided with cursor keys, numeric input keys, various function keys, and the like, and a pointing device such as a mouse, and outputs an instruction signal input by a key operation on the keyboard or a mouse operation to the imaging controller 31. In addition, the operation unit 35 may include a touch panel on the display screen of the display 34, and in this case, outputs an instruction signal input via the touch panel to the imaging controller 31.

Next, details of control related to image processing in the imaging controller 31 according to the present embodiment will be described. FIG. 4 is a block diagram illustrating a configuration of the imaging controller 31. The imaging controller 31 corresponds to an “image processing apparatus” in the present invention.

In the present embodiment, during one imaging operation of the radiographic imaging system 100, a main image and a preview image are displayed on the display 34, the preview image being displayed before the main image is displayed. Specifically, in the flow of image display in one imaging operation by the radiographic imaging system 100, first, the preview image is displayed on the display 34 such that, for example, a wipe image is displayed, and then, the entire preview image is displayed. Thereafter, the main image is displayed.

The main image is, for example, an output image as a result of image capture in one imaging operation by the radiographic imaging system 100, and is an output image subjected to relatively high-precision image processing (for example, subjected to processing for increasing resolution) on image data acquired from the radiographic imaging apparatus 2.

The preview image is, for example, an output image output prior to the main image described above, and is an output image subjected to simpler image processing than the main image (for example, having resolution lower than that of the main image).

The wipe image is, for example, an output image output prior to the preview image, and is an output image having a resolution lower than that of the main image and not subjected to image processing or subjected to image processing simpler than that for the preview image.

In the present embodiment, the preview image is displayed prior to the main image, whereby a radiographer (user) such as a radiologist can check the image in real time for assessing whether or not the subject is appropriately imaged by referring to the preview image.

The imaging controller 31 displays, on the display 34, a preview image and a main image obtained by applying image processing to the image signal (image data) acquired from the radiographic imaging apparatus 2. As illustrated in FIG. 4, the imaging controller 31 includes an image data generator 31A, an image processor 31B, and a display controller 31C.

The image data generator 31A generates image data (display image data) to be displayed on the display 34 on the basis of the image signal acquired from the radiographic imaging apparatus 2. The display image data is, for example, image data for a preview image (hereinafter referred to as preview image data) and image data for a main image (hereinafter referred to as main-image image data).

That is, the image data generator 31A generates the preview image data and the main-image image data on the basis of the image signal acquired from the radiographic imaging apparatus 2.

The image processor 31B performs enhancement processing for enhancing a signal component of a predetermined structure on the preview image data generated by the image data generator 31A. The predetermined structure is a medical product other than a human body to be inserted into a body of a patient (subject) by examination, surgery, or the like, and is, for example, at least one of a catheter, a gauze, tweezers, or a tube.

The enhancement processing is, for example, frequency enhancement processing for enhancing a signal component in a frequency band that is determined in advance based on a structure. In addition, a known technique including processing for performing edge detection such as a Laplacian filter or processing for performing detection using machine learning based on a map representing an image related to a predetermined structure and a correct area can be applied to the enhancement processing.

In general, in order to check, by a user, whether or not a position of a medical instrument (for example, the position of the distal end of a catheter, etc.) inserted into a body of a patient (subject) is appropriate or whether or not a medical supply (for example, a gauze or the like) remains in the body of the patient, a radiographic image of the inside of the body of the patient may be obtained using the radiographic imaging system 100.

In the present embodiment, in a case where a predetermined structure is present in the preview image data, the image processor 31B performs enhancement processing such that a portion related to the predetermined structure is enhanced. As a result, the predetermined structure is enhanced in the image on which the enhancement processing has been performed, and the user can easily visually recognize the structure in the image.

The display controller 31C displays, on the display 34, a preview image based on the preview image data in which the signal component of the predetermined structure is enhanced by the image processor 31B.

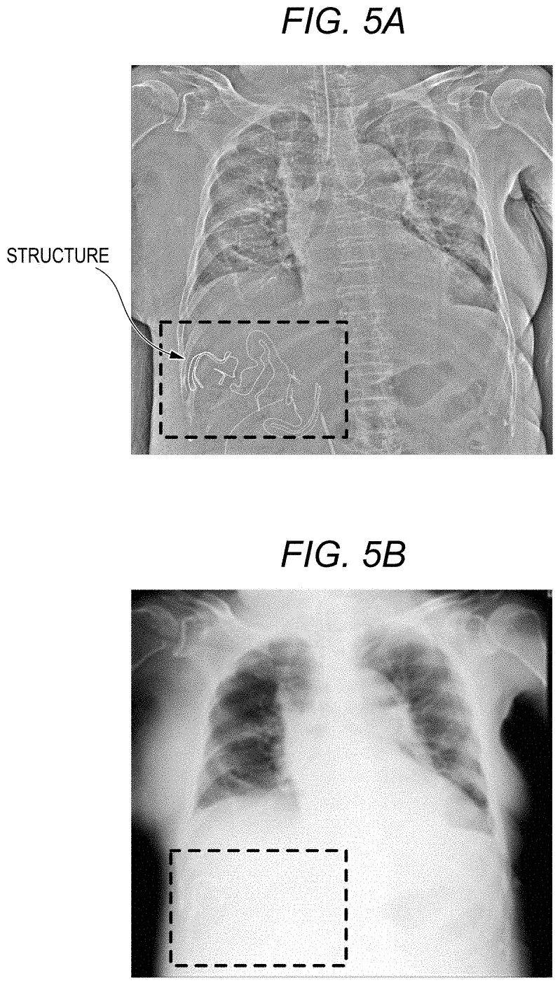

Displaying the preview image subjected to the abovementioned enhancement processing on the display 34 enables the user to recognize the predetermined structure easily visually in the preview image as illustrated in, for example, FIG. 5A. FIG. 5A illustrates an example in which a structure (gauze or the like) present in a region surrounded by a broken line in the preview image is displayed while being enhanced using a white line.

Note that FIG. 5B illustrates an image in which the enhancement processing is not performed on the image illustrated in FIG. 5A. A region where a structure is present (a region surrounded by a broken line) in the image illustrated in FIG. 5A is entirely displayed in white, and it is difficult for the user to visually recognize whether or not the structure is present.

With this configuration, it is possible to check whether or not a structure is present within the body of the subject in the preview image.

Conventionally, such a configuration is commonly known in which, for example, after a main image not subjected to enhancement processing is displayed, a user operates a predetermined operation unit, for example, by pressing an operation button for the enhancement processing, by which the display is switched to an image subjected to the enhancement processing, and the user checks the image.

With such a configuration, it is necessary to perform the above operation after the main image is displayed. This is troublesome and inconvenient for the user, and may cause a delay in checking an image related to the inside of the body of the subject. In particular, in a situation where it is necessary to perform surgery immediately after it is checked whether or not a structure is present within the body of the subject, a time loss due to the troublesome operation described above has a considerable influence. That is, in a case where it is desired to quickly check whether or not a structure (particularly, a gauze or the like) is present within the body of the subject, such as during surgery, the delay in checking the image related to the inside of the body of the subject exerts a considerable influence.

On the other hand, in the present embodiment, the presence or absence of the structure within the body of the subject can be checked in the preview image before the main image is displayed. Therefore, when the main image is displayed and the imaging operation is completed, a doctor or the like can quickly shift to the next action.

That is, in the present embodiment, it is possible to quickly check whether or not a structure is present within the body of a subject and to consequently improve the immediacy of checking an image in the radiographic imaging system 100.

In addition, the image processor 31B performs enhancement processing for enhancing a signal component of a predetermined structure on the main-image image data generated by the image data generator 31A. Then, the display controller 31C displays, on the display 34, a main image based on the main-image image data in which the signal component of the predetermined structure is enhanced by the image processor 31B.

As a result, it is possible to eliminate the operation on the operation unit as in the related art for checking a structure in the main image, and thus, it is possible to improve the immediacy of checking an image in the radiographic imaging system 100.

In addition, the display controller 31C may further display, on the display 34, a non-enhanced image that is an image in which a signal component of a predetermined structure is not enhanced in image data. In the present embodiment, after the wipe image is displayed, the preview image is displayed on the display 34. However, for example, the wipe image may be displayed on the display 34 as a non-enhanced image.

With this configuration, the user can easily check both the non-enhanced image and the image subjected to the enhancement processing.

In addition, when display setting for displaying the preview image based on the preview image data subjected to the enhancement processing is set at the start of image capture by the radiographic imaging apparatus 2, the display controller 31C displays the preview image on the display 34.

For example, in a case where the operation unit 35 can set whether or not enhancement processing is performed on the display image data, the user makes a display setting so that the preview image (main image) based on the enhancement processing is displayed, before starting image capture by the radiographic imaging system 100.

Examples of a method for setting whether or not the enhancement processing is performed include a method for collectively setting whether or not the enhancement processing is performed, a method for setting whether or not the enhancement processing is performed for each of a part to be imaged, and a method for setting whether or not the enhancement processing is performed separately for each modality such as computed radiography (CR) or digital radiography (DR) on the radiographic imaging system 100. In addition, when DR is used in the method for setting whether or not the enhancement processing is performed separately for each modality, an image can be immediately displayed, which is convenient for the user. In addition, when CR is used, it is necessary to read image data with a reading device or the like, and thus, an image is checked at a place different from the place where the image is captured.

Whether or not the enhancement processing is performed may be set in advance as the setting of the radiographic imaging system 100, or may be set by the user immediately before image capture. In a case where the user sets whether or not the enhancement processing is performed immediately before image capture, the user can be freely set according to situations by his/her determination, and thus, the convenience for the user is improved.

Then, in a case where the display setting for preview image is set, the display controller 31C displays a preview image based on the enhancement processing on the display 34. In a case where the display setting for preview image is not set, the display controller 31C displays a preview image not subjected to the enhancement processing on the display 34.

With this configuration, when there is a need to check the presence of a structure within the body of the subject, it is only sufficient that the preview image based on the enhancement processing is displayed, so that an appropriate image according to purposes can be displayed.

Furthermore, the display controller 31C may display the preview image and the main image on the entire display 34. For example, in a case where the monitor serving as the display 34 has a rectangular shape (a horizontally long shape of a wide monitor or the like in which the long side direction is along the horizontal direction) and the captured image has a vertically long shape in which the long side direction is along the vertical direction, the display controller 31C rotates the image so that the long side direction of the image is along the horizontal direction and displays the image on the display 34. As a result, a larger image is displayed, so that the user can easily check the image displayed on the display 34.

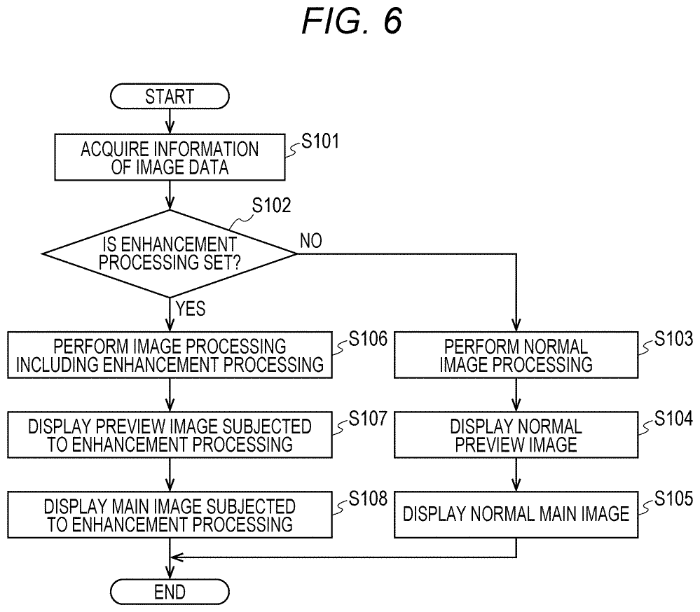

An operation example of the enhancement processing control for the preview image by the imaging controller 31 configured as described above will be described. FIG. 6 is a flowchart illustrating an operation example of the enhancement processing control for the preview image by the imaging controller 31. The processing in FIG. 6 is executed as appropriate, when, for example, the imaging operation by the radiographic imaging system 100 is started.

As illustrated in FIG. 6, the imaging controller 31 acquires information of image data (step S101). The imaging controller 31 determines whether or not display setting regarding enhancement processing for preview image is set (step S102).

When the display setting regarding enhancement processing is not set as a result of the determination (step S102, NO), the imaging controller 31 executes normal image processing (step S103). The normal image processing refers to image processing performed when an image not subjected to the enhancement processing is displayed on the display 34. Note that the normal image processing may be performed by the image processor 31B or may be performed by another processor.

After step S103, the imaging controller 31 displays a normal preview image, that is, a preview image not subjected to the enhancement processing (step S104). Thereafter, the imaging controller 31 displays a normal main image, that is, a main image not subjected to the enhancement processing (step S105).

When the display setting regarding enhancement processing is set as a result of the determination in step S102 (step S102, YES), the imaging controller 31 executes image processing including the enhancement processing (step S106). The image processing including the enhancement processing refers to image processing performed when an image obtained by performing enhancement processing on a signal component of a predetermined structure is displayed on the display 34.

After step S106, the imaging controller 31 displays a preview image subjected to the enhancement processing (step S107). Thereafter, the imaging controller 31 displays a main image subjected to the enhancement processing (step S108). After step S105 or step S108, this control ends.

According to the present embodiment configured as described above, it is possible to quickly check whether or not a structure is present within the body of a subject and to consequently improve the immediacy of checking an image in the radiographic imaging system 100.

Note that, although the enhancement processing is performed on the preview image and the main image in the above embodiment, the present invention is not limited thereto, and the enhancement processing may be performed only on the preview image.

Alternatively, the enhancement processing may be performed only on the main image without performing the enhancement processing on the preview image. In this case, from the viewpoint of the immediacy of checking an image, the operation unit 35 needs to be configured so that whether or not the enhancement processing is performed on the main image can be set, for example. The operation unit 35 corresponds to a “setter” in the present invention.

In this configuration, when the enhancement processing is set to be performed on the display image data by the operation unit 35, the display controller 31C displays an image based on the display image data (main image data) in which a signal component of a catheter/gauze region is enhanced by the image processor 31B on the display 34 in preference to an image in which the signal component of the catheter/gauze region is not enhanced.

That is, in this configuration, the image processor 31B enhances the signal component of the catheter/gauze region in the main image data among the preview image data and the main image data, and the display controller 31C displays the preview image not subjected to the enhancement processing on the display 34, and then displays the main image subjected to the enhancement processing on the display 34.

The catheter/gauze region represents a region indicating at least one of a catheter or a gauze inserted into the body of the subject.

In an examination, it is not preferable that the gauze remains in the body of the subject, and thus, it is necessary to quickly detect the gauze by image capture by the radiographic imaging system 100. In addition, it is necessary to quickly detect whether or not the position of the distal end of the catheter is appropriate from the viewpoint of quickly performing the examination. In the present embodiment, when the main image is displayed on the display 34, the main image subjected to the enhancement processing is preferentially displayed. As a result, it is possible to improve the immediacy of checking an image as compared with a configuration in which a main image not subjected to the enhancement processing is displayed, and then, a main image subjected to the enhancement processing is displayed through a predetermined operation.

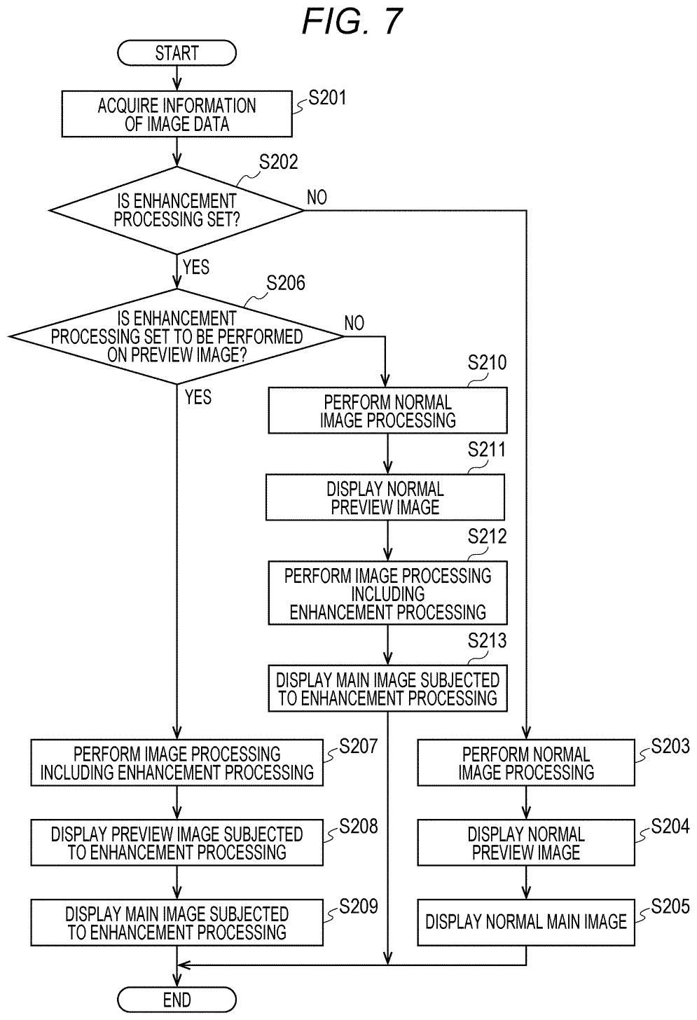

An operation example of the enhancement processing control for an image by the imaging controller 31 configured as described above will be described. FIG. 7 is a flowchart illustrating an operation example of the enhancement processing control for an image by the imaging controller 31. The processing in FIG. 7 is executed as appropriate, when, for example, an imaging operation by the radiographic imaging system 100 is started.

As illustrated in FIG. 7, the imaging controller 31 acquires information of image data (step S201). The imaging controller 31 determines whether or not display setting regarding enhancement processing for an image is set (step S202). When the display setting regarding enhancement processing is not set as a result of the determination (step S202, NO), the imaging controller 31 executes normal image processing (step S203).

After step S203, the imaging controller 31 displays a normal preview image, that is, a preview image not subjected to the enhancement processing (step S204). Thereafter, the imaging controller 31 displays a normal main image, that is, a main image not subjected to the enhancement processing (step S205).

When the display setting regarding enhancement processing is set as a result of the determination in step S202 (step S202, YES), the imaging controller 31 determines whether or not setting for performing the enhancement processing on the preview image is set (step S206).

When the setting for performing the enhancement processing on the preview image is set as a result of the determination (step S206, YES), the imaging controller 31 executes image processing including the enhancement processing (step S207). The image processing including the enhancement processing refers to image processing performed when an image obtained by performing enhancement processing on a signal component of a catheter/gauze region is displayed on the display 34.

After step S207, the imaging controller 31 displays the preview image subjected to the enhancement processing (step S208). Thereafter, the imaging controller 31 displays the main image subjected to the enhancement processing (step S209).

When the setting for performing the enhancement processing on the preview image is not set, that is, the enhancement processing is set to be performed only for the main image as a result of the determination of step S206 (step S206, NO), the imaging controller 31 executes normal image processing (step S210) and displays a normal preview image (step S211).

After step S211, the imaging controller 31 executes image processing including the enhancement processing (step S212), and displays the main image subjected to the enhancement processing (step S213). After step S205, step S209, or step S213, this control ends.

According to such a configuration, the main image subjected to the enhancement processing is displayed according to the display setting regarding the enhancement processing, whereby it is possible to improve the immediacy of checking an image.

In addition, this configuration makes it possible to eliminate the process of performing the enhancement processing on the preview image, and consequently, the processing time is shortened. Thus, this configuration is useful in a case where it is desired to check the catheter/gauze region in the image subjected to the high-precision image processing such as the main image.

In addition, although it is determined in the above embodiment whether or not the enhancement processing is performed on the preview image or the like according to the display setting regarding the enhancement processing, the present invention is not limited thereto. For example, the enhancement processing may be forcibly performed on the preview image or the like during the imaging operation by the radiographic imaging system. Further, in the radiographic imaging system according to the flowchart illustrated in FIG. 7, when the display setting regarding the enhancement processing is set, the enhancement processing may be performed only on the main image without determining the setting regarding the enhancement processing on the preview image.

In addition, in the above embodiment, since either the preview image or the main image is displayed on the entire display 34, either the image subjected to the enhancement processing or the image not subjected to the enhancement processing is displayed, but the present invention is not limited thereto. For example, the image subjected to the enhancement processing and the image not subjected to the enhancement processing may be simultaneously displayed on the display 34.

In the above embodiment, the imaging controller 31 of the console 3 constitutes the image processing apparatus. However, the present invention is not limited thereto. An apparatus other than the imaging controller of the console, such as a controller of the radiographic imaging apparatus or an apparatus outside the radiographic imaging system (for example, a mobile terminal, a PC, or the like), may constitute the image processing apparatus. In addition, the mobile terminal includes a personal digital assistant (PDA), a mobile phone such as a smartphone, a tablet terminal, and the like.

Further, in the above embodiment, the image data generator, the image processor, and the display controller are incorporated in the imaging controller, but the present invention is not limited thereto, and the image data generator, the image processor, and the display controller may be separately provided.

In addition, the above embodiment merely shows a specific example for implementing the present invention, and the technical scope of the present invention should not be construed as being limited by the above embodiment. That is, the present invention can be implemented in various modes without departing from the gist or major features of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus comprising:
an image data generator that generates preview image data and main-image image data on the basis of an image signal acquired by a radiographic imaging apparatus;
an image processor that performs enhancement processing for enhancing a signal component of a predetermined structure other than a human body on the preview image data generated by the image data generator; and
a display controller that displays, on a display, a preview image based on the preview image data in which the signal component of the predetermined structure has been enhanced by the image processor.

2. The image processing apparatus according to claim 1, wherein
the predetermined structure is at least one of a catheter, a gauze, tweezers, or a tube.

3. The image processing apparatus according to claim 1, wherein
the display controller displays the preview image on the display by performing frequency processing for enhancing a signal component in a predetermined frequency band on image data.

4. The image processing apparatus according to claim 1, wherein
the display controller further displays, on the display, a non-enhanced image that is an image obtained by not performing the enhancement processing on image data.

5. The image processing apparatus according to claim 4, wherein
the display controller displays the preview image on the display after displaying the non-enhanced image on the display.

6. The image processing apparatus according to claim 1, wherein
when display setting for displaying a preview image based on the preview image data subjected to the enhancement processing is set upon starting image capture by the radiographic imaging apparatus, the display controller displays the preview image on the display.

7. An image processing apparatus comprising:
an image data generator that generates display image data on the basis of an image signal acquired by a radiographic imaging apparatus;
an image processor that performs enhancement processing for enhancing a signal component of at least one region of a catheter or a gauze on the display image data generated by the image data generator;
a setter that sets the enhancement processing for enhancing the signal component of the region; and
a display controller that displays, on a display, an image based on display image data in which the signal component of the region has been enhanced by the image processor in preference to an image in which the signal component of the region has not been enhanced, when the enhancement processing is set by the setter.

8. The image processing apparatus according to claim 7, wherein
the image data generator generates preview image data and main-image image data as the display image data, and
the image processor performs the enhancement processing for enhancing the signal component of the region on the main-image image data.

9. A display method for displaying an image pertaining to a radiographic imaging apparatus on a display, the method comprising:
generating preview image data and main-image image data on the basis of an image signal acquired by the radiographic imaging apparatus;
performing enhancement processing for enhancing a signal component of a predetermined structure other than a human body on the preview image data that has been generated; and
displaying, on the display, a preview image based on the preview image data in which the signal component of the predetermined structure has been enhanced.

10. A non-transitory recording medium storing a computer readable display program for displaying an image pertaining to a radiographic imaging apparatus on a display, the program causing a computer to perform:
generating preview image data and main-image image data on the basis of an image signal acquired by the radiographic imaging apparatus;
performing enhancement processing for enhancing a signal component of a predetermined structure other than a human body on the preview image data that has been generated; and
displaying, on the display, a preview image based on the preview image data in which the signal component of the predetermined structure has been enhanced.
